(19) United States
(12) Patent Application Publication
(10) Pub. No.: US 2007/0141213 A1
(43) Pub. Date: Jun. 21, 2007

(54) Process for making nutritional snack food

(76) Inventor: Roger H. Wang, Santa Ana, CA (US)

Correspondence Address: LAW OFFICES OF J.F. LEE, 17800 CASTLETON STREET, SUITE 383, CITY OF INDUSTRY, CA, 91748, US

(21) Appl. No.: 11/306,287

(22) Filed: Dec. 21, 2005

(51) Int. Cl. A23G 3/20

(52) U.S. Cl. 426/306

(57) ABSTRACT

A process for making nutritional snack food based on fruits and/or vegetables and chocolate. By presenting to consumers easy combination of the requisite fibres, minerals, vitamins and anti-oxidant, consumers will benefit from the claimed process of producing snack food.

### FIELD AND BACKGROUND OF THE INVENTION

The present invention relates generally to a process for making nutritional snack food that aids the intake of several important nutrients to humans, especially in today's busy daily lives.

The constituent elements, vegetables, fruits and chocolate, especially dark chocolate, of present invention are available in many different sources. However, to obtain the benefits of these nutrients in a convenient manner, consumers of today do not have the time and opportunity to easily obtain the requisite amount of intake as suggested by doctors and health professionals.

### OBJECTS AND SUMMARY OF THE INVENTION

Present invention provides a convenient product to give consumers an easy way of food intake for the requisite of amount of various nutrients, in a unique combination of vegetables, fruits and chocolate including dark chocolate.

Fruits and vegetables are rich in the content of fibres, minerals and vitamins. While chocolate, especially dark chocolate, has been known by medical researchers to contain high potency anti-oxidants, which are valuable in improving health.

Products made pursuant to the disclosure of present invention provide the equivalent amount of necessary nutrients by lesser weight and in more convenient manner than if all the requisite nutrients must be acquired by consumers individually.

Although there are known prior art products or the processes of making nutritional snack foods, they are vastly different from present invention, which involves the use of freeze-dry process on fruits or vegetables and then add a coating of chocolate.

For example, U.S. Pat. No. 6,953,597 by inventor Alan Thorpe (“Thorpe 597 Patent”) disclosed and claimed a “batter coating for potato pieces”, wherein the purpose of the invention is to avoid the “undesirably limp, soggy and tough French fry”, due to the re-hydration of the batter on the surface of French fry after some duration of elapsed time.

Thorpe 597 Patent involves no chocolate or freeze-dry, both are requisite elements of present invention.

U.S. Pat. No. 6,821,537 by inventor Rei-Young Amos Wu (“Wu 537 Patent”) disclosed and claimed a process for preparing hand-held snack item, wherein a coating is applied as a protective mechanism for the grain cake or rice cake.

Wu 537 Patent lacks present invention's vegetables or fruits. Wu 537 Patent further lacks the requisite process of freeze-dry on its grain or rice cake.

U.S. Pat. No. 5,194,278 by inventor David R. Strong (“Strong 278 Patent”) disclosed and claimed “fruit-flavored roasted nuts”. Strong 278 Patent involves roasted snack food. Present invention's snack, as produced by the claimed process, can NOT be roasted. Further, Strong 278 Patent's coating material is mixture of fruit juice solids and water, whereas present invention's coating is chocolate.

U.S. Pat. No. 5,147,669 by inventor William G. Crothers (“Crothers 669 Patent”) disclosed and claimed “edible cookie bits products” that are baked, involving NO freeze-dry process of present invention. Crothers 669 Patent further does not involve the ingredients of fruits or vegetables.

U.S. Pat. No. 4,568,557 by inventor Amy J. Becker, et al. (“Becker 557 Patent”) disclosed and claimed “process for producing snack food product with high dietary fiber content” that involves mixing the material in oil. Becker 557 Patent's coating material further contains fractionated fat.

Present invention has NO oil or fractionated fat. Becker 557 Patent does NOT produce the snack food by freeze-dry method. Becker 557 further does NOT have chocolate.

U.S. Pat. No. 4,499,113 by inventor Keizo Mochizuki, et al. (“Mochizuki 113 Patent”) disclosed and claimed “process for preparing snack products with expanded coating”. Mochizuki 113 Patent is completely different from present invention in that its coating material is essentially edible fatty confectionary material and relies upon frying, NOT freeze-dry.

### DETAILED DESCRIPTION OF THE PREFERRED EMBODIMENT

Prepare proper amount of vegetables and fruits. There is no constraint as to any ration between vegetables and fruits. Any ratio is workable for purpose of this invention.

Said vegetables and fruits can be cut to be smaller pieces, depending the size desired. Some vegetables or fruits may need no further cutting at all, depending on their natural size.

Freeze-dry the aforesaid vegetables and/or fruits.

Prepare chocolate, especially dark chocolate, that will be coated upon the outside surface of the aforesaid vegetables and/or fruits. This chocolate coating is to give the nutritional content of anti-oxidant to the fruits/vegetables being coated upon. There is no need to completely cover the outside surface. In other words, the chocolate coating is not to form any protective layer on the outside.

What is claimed is:

1. A process for making nutrition-rich snack food, comprising:
a. Freeze-dry fruits or vegetables that have been cleaned and prepared,
b. Apply a coat of chocolate on the outer surface; and,
c. Allow the chocolate to coagulate and collect the coated fruits or vegetables for packaging.

2. The process of claim 1, wherein the fruits or vegetables are pre-cut into different shapes before freeze-dry.

3. The process of claim 1, wherein the chocolate used for coating is dark chocolate.
